(19) United States
(12) Patent Application Publication
(10) Pub. No.: US 2026/0088600 A1
(43) Pub. Date: Mar. 26, 2026

(54) LINKAGE SYSTEM

(71) Applicant: Hubbell Incorporated, Shelton, CT (US)

(72) Inventor: Stephen Andrew Skolozdra, Brooklyn, MS (US)

(21) Appl. No.: 19/338,599

(22) Filed: Sep. 24, 2025

Related U.S. Application Data
(60) Provisional application No. 63/698,664, filed on Sep. 25, 2024.

(51) Int. Cl. H02G 7/06; H02G 7/04

(52) U.S. Cl. CPC H02G 7/06; H02G 7/04

(57) ABSTRACT

A linkage includes a first portion for connecting to a structure, and a second portion to retain a cable therein such that the cable is supported by the structure. The cable runs between a main service connection and a user connection. The linkage is formed such that the cable detaches from the structure at a predetermined load value applied to the cable.

### CROSS-REFERENCE TO RELATED APPLICATIONS

This application claims priority to U.S. Provisional Application No. 63/698,664, filed Sep. 25, 2024, the entire contents of which is hereby incorporated by reference herein.

### FIELD

The present disclosure relates generally a linkage system for supporting wire running between a main service connection and a structure.

### BACKGROUND

Wires can be suspended to extend between a main service connection and a structure, for example between a telephone pole and a home or other structure where service provided by the wire is desired. In some situations, for example during a storm or during high winds, trees, tree branches, ice, or other debris can fall onto the suspended wire and cause the suspended wire to break.

### BRIEF DESCRIPTION

Aspects and advantages of embodiments of the present disclosure will be set forth in part in the following description, or may be learned from the description, or may be learned through practice of the embodiments. The following aspects are combinable with one another to results in embodiments not specifically described herein.

In some aspects, the structures described herein relate to a linkage for retaining a cable to a structure, the cable being configured to run between a main service connection and a user connection, the linkage including: a first portion configured to connect to the structure, and a second portion configured to retain the cable therein such that the cable is retained to the structure via the first portion, wherein the linkage is configured such that the cable detaches from the structure at a predetermined load value applied to the cable.

In some aspects, the structures described herein relate to a linkage, wherein the predetermined load value is 100 lbs to 600 lbs.

In some aspects, the structures described herein relate to a linkage, wherein the first portion includes a loop for attaching to the structure and a first portion connector, wherein the second portion includes a cable retainer and a second portion connector that is connectable to the first portion connector, and wherein the first portion connector and the second portion connector are configured to detach from one another when the predetermined load value is reached.

In some aspects, the structures described herein relate to a linkage, wherein a link connects the first portion connector to the second portion connector, and wherein the link is configured to break at a predetermined tensile load applied between the first portion connector and the second portion connector.

In some aspects, the structures described herein relate to a linkage, wherein the link includes a first portion, a second portion, and a third portion, wherein the first portion is connected to the first portion connector, and wherein the third portion is connected to the second portion connector.

In some aspects, the structures described herein relate to a linkage, wherein the second portion connects the first portion to the third portion, and wherein the second portion has a smaller cross-sectional area than the first portion and the third portion.

In some aspects, the structures described herein relate to a linkage, wherein the first portion includes a first through-hole and the third portion includes a second through-hole, wherein the first portion is connected to the first portion connector via a first bolt that passes through the first through-hole, and wherein the third portion is connected to the second portion connector via a second bolt that passes through the second through-hole.

In some aspects, the structures described herein relate to a linkage, wherein the link is metal.

In some aspects, the structures described herein relate to a linkage, wherein the link is received within the first portion connector and the second portion connector.

In some aspects, the structures described herein relate to a linkage, wherein the first portion connector sits flush against the second portion connector.

In some aspects, the structures described herein relate to a linkage, wherein the first portion includes a loop for attaching to the structure and a first portion connector, wherein the second portion includes an area for receiving the cable and a second portion connector that is connectable to the first portion connector, and wherein the first portion connector and the second portion connector are configured to detach from one another when the predetermined load value is reached.

In some aspects, the structures described herein relate to a linkage, wherein the area for receiving the cable is delimited by a first arm and a second arm spaced apart from the first arm, and wherein the area for receiving the cable is located between the first arm and the second arm.

In some aspects, the structures described herein relate to a linkage, wherein the second arm includes an elbow at an end of the second arm opposite of the second portion connector, and wherein the elbow is attached to a gate, and the gate is configured to be actuated in contact with and out of contact with the first arm.

In some aspects, the structures described herein relate to a linkage, wherein the elbow and the gate also delimit the area for receiving the cable.

In some aspects, the structures described herein relate to a linkage, wherein the elbow is deformable at a flexing location such that the gate is movable between a first position and a second position, the gate contacting the first arm in the first position and being spaced away from the first arm in the second position.

In some aspects, the structures described herein relate to a linkage, wherein the first arm includes a tooth in part defined by a notch, and wherein the gate is configured to, in the first position, extend at least partially around the tooth to seat within the notch.

In some aspects, the structures described herein relate to a linkage, wherein the linkage is a bracket that is configured to attach directly to the structure, the bracket including a first member and a second member spaced apart from the first member to define a receiving space therebetween, the receiving space configured to receive and retain the cable until the predetermined load value is applied to the cable.

In some aspects, the structures described herein relate to a linkage, wherein the bracket includes an aperture configured to receive a fastener to attach the bracket to the structure, and wherein the bracket includes a counterbore around the aperture, the counterbore being configured to receive a head of the fastener.

In some aspects, the structures described herein relate to a linkage, wherein the first member and the second member attach to a plate configured to sit flush against the structure in an installed position.

In some aspects, the structures described herein relate to a linkage, wherein the bracket is one of a plurality of brackets, and wherein the linkage is an assembly including the plurality of brackets.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which refers to the appended figures, in which:

FIG. 1 illustrates a system for providing wired service to a structure.

FIG. 2 illustrates an isometric view of a linkage for use in the system of FIG. 1.

FIG. 3 illustrates an assembly view of the linkage of FIG. 2.

FIG. 4 illustrates a side view of the linkage of FIG. 2.

FIG. 5 illustrates another isometric view of the linkage of FIG. 2.

FIG. 6 illustrates another assembly view of the linkage of FIG. 2.

FIG. 7 illustrates a front view of the linkage of FIG. 2.

FIG. 8 illustrates an isometric view of a linkage for use in the system of FIG. 1.

FIG. 9 illustrates a side view of the linkage of FIG. 8.

FIG. 10 illustrates an assembly view of the linkage of FIG. 8.

FIG. 11 illustrates an isometric view of a linkage for use in the system of FIG. 1.

FIG. 12 illustrates a linkage assembly using the linkage of FIG. 11.

FIG. 13 illustrates an isometric view of a linkage for use in the system of FIG. 1.

FIG. 14 illustrates an assembly view of the linkage of FIG. 13.

FIG. 15 illustrates a link used with the linkage of FIG. 13.

FIG. 16 illustrates the linkage of FIG. 13 in use.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

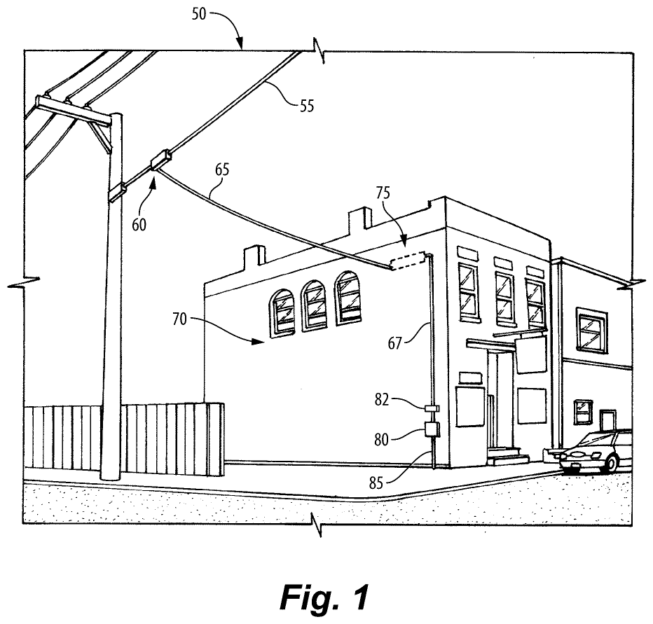

FIG. 1 illustrates a system 50 for providing wired service to a structure 70. The structure 70 is, for example, a home or business and the wired service is, for example, electrical power or an internet connection. The service to the structure comes from a main service line 55. A wire or cable 65 is connected to the main service line 55 at a main service connection 60. The cable 65 runs between the main service line 55 and a user connection 85. The cable 65 connects to the structure 70 to provide the service to the structure 70. In examples where the service is an internet connection having a fiber optic internet connection, the cable 65 connects to an optical network terminal 80, which in turn connects the service to the structure 70 via the user connection 85. The optical network terminal 80 converts a signal in the fiber optic cable, cable 65 in as illustrated in FIG. 1, to an electrical signal for use in an ethernet or phone connection, e.g., in the user connection 85 as illustrated in FIG. 1.

The cable 65 is elevated in a span from the main service connection 60 to the structure 70. In some situations, for example during a storm or during high winds, trees, tree branches, ice, or other debris can fall onto the cable 65 and cause the cable 65 to break. To protect the optical network terminal 80, a clamp 82 is installed onto the structure 70 to prevent the cable 65 from pulling out of the optical network terminal 80 and thus causing damage therein. However, even if the optical network terminal 80 is protected by the clamp 82, the trees, tree branches, ice, or other debris can fall onto the suspended cable 65 and cause the cable 65 to break, thereby disrupting the service to the structure 70. Especially in rural areas, making repairs to and/or replacing the cable 65 can be costly and time consuming, and thus returning service to the structure 70 can often take days or weeks.

To reduce instances of the cable 65 breaking during storms or high wind events, a linkage 75 is provided. The linkage 75 attaches to the structure 70 and to the cable 65 and serves as an intermediate connection between the clamp 82 and the main service connection 60. A slack portion 67 of the cable 65 extends between the clamp 82 and the linkage 75. The linkage 75 releases in response to a predetermined load value of about, for example, 100 lbs. to 600 lbs. Thus, as one example, if during a storm a tree fell on a portion of the cable 65 between the linkage 75 and the main service connection 60, the force of the tree on the cable 65 would cause the linkage 75 to release and detach the cable 65 from the structure 70. The slack portion 67 of the cable 65 is long enough that, when the linkage 75 releases, the cable 65 lays on the ground. Thus, force from the tree falling on the cable 65 is significantly less likely to snap the cable 65 between the fixed connections at the clamp 82 and the main service connection 60. However, the linkage 75 must be strong enough to support the cable 65, which is subjected to loads in normal operation (e.g., from the weight of the cable 65 over the elevated span of the cable 65), such that the linkage 75 does not release under a normal, static load conditions or during minor wind loads.

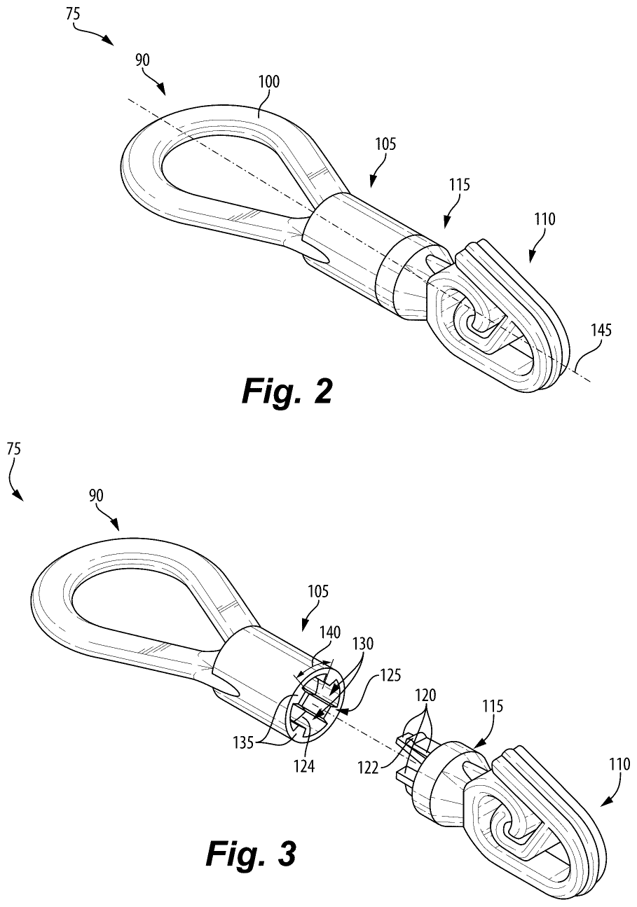

In one example, which is shown in FIGS. 2-7, the linkage 75 includes a first portion 90 and a second portion 95. The first portion 90 interlocks with the second portion 95, and, in use, supports the cable 65 on the structure 70. However, if a load on the linkage 75 exceeds the predetermined load value, for example, in the form of a tensile force, the first portion 90 separates from the second portion 95 such that the cable 65 is no longer supported, and therefore can fall to the ground. To achieve this, the first portion 90 includes a loop 100 for attaching to the structure 70. While the loop 100 illustrated herein is generally elliptical, the loop 100 could be square, rectangular, or any other shape to best connect to the structure 70. In some examples, the structure 70 includes a mount such as a “ram's horn” style mount that the loop 100 attaches to. The first portion 90 also includes a first portion connector 105 that connects to the second portion 95, and more specifically connects to a second portion connector 115. The second portion 95 also includes a cable retainer 110, which retains the cable 65 therein. FIG. 2 illustrates the linkage 75 when the first portion 90 is connected to the second portion 95, and FIG. 3 illustrates the linkage 75 when the first portion 90 is disconnected from the second portion 95. In FIG. 3, tines 120 are visible on the second portion connector 115, which extend into a cavity 125 located within the first portion connector 105 when the first portion 90 is connected to the second portion 95. The cavity is divided into numerous tine receiving regions 130, which each receive a respective tine 120. Four tines 120 and corresponding tine receiving regions 130 are illustrated in FIG. 3, although more or less tines 120 and corresponding tine receiving regions 130 are contemplated. The tines 120 and corresponding tine receiving regions 130 are spaced apart about an interior circumference of the cavity 125 of the first portion connector 105. In some examples, the first portion connector 105 includes more tine receiving regions 130 than there are tines 120 on the second portion connector 115. As the tines are inserted into the tine receiving regions 130, a protrusion 122 on each of the tines 120 is inserted beyond, and then rests against, a lip 124 within the cavity 125. The protrusion 122 resting on the lip 124 retains the first portion connector 105 against the second portion connector 115 until a force acting on the cable retainer 110 separates the first portion 90 from the second portion 95.

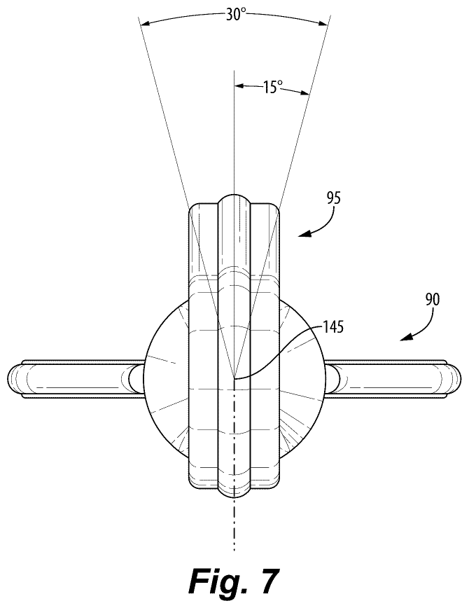

As shown in FIG. 3, the tine receiving regions 130 are separated by barriers 135 spaced about an outer circumference of the cavity 125. The barriers 135 prevent the tines 120 from rotating within the cavity 125, and more specifically, prevent the second portion connector 115 from rotating relative to the first portion connector 105 about a longitudinal axis 145 defined by centerlines of the generally cylindrical first and second portion connectors 105, 115. However, in some examples, the tines 120 are narrower than an arcuate width 140 of the receiving region 130 such that the second portion connector 115 is allowed to rotate relative to the first portion connector 105 about the longitudinal axis 145. For example, FIG. 7 illustrates an example where the arcuate width 140 allows the second portion connector 115 to rotate up to 30° relative to the first portion connector 105. Other examples are contemplated with relative rotation ranging from 0 to 90° or more. The degree of rotation allows the cable 65 to be better positioned in the linkage 75 relative to the structure 70, thus limiting or removing kinking and/or areas of increased stress on the cable 65.

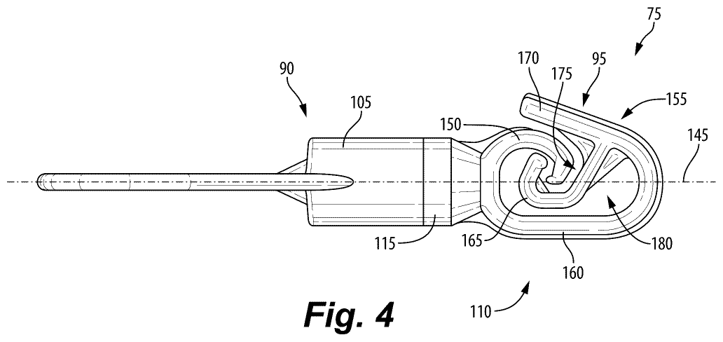

Referring now to FIG. 4, which provides a side view of the cable retainer 110, the cable retainer 110 includes a spur 150 and a cantilevered portion 155. Together, the spur 150 and the cantilevered portion 155 form a circuitous path 175 leading to a main cavity 180. When the linkage 75 is in use, the cable 65 sits within the main cavity 180. To insert and remove the cable 65 from the main cavity 180, the cable 65 must be passed through the circuitous path 175. The circuitous path 175 prevents the cable 65 from falling out of the cable retainer 110, for example when winds act on the cable 65 when the cable 65 is elevated. The circuitous path 175 illustrated herein is formed by a finger 170 of the cantilevered portion 155 and a hooked portion 165 of the cantilevered portion 155 passing on opposite sides of the spur 150. An elongated portion 160 connects both the hooked portion 165 and the finger 170 to the second portion connector 115. Thus, for the cable 65 to pass to or from the main cavity 180, the cable 65 will have to pass around the spur 150 by passing along both the finger 170 and the hooked portion 165, and will then have to pass back on an other side of the hooked portion 165 along the elongated portion 160 to reach the main cavity 180.

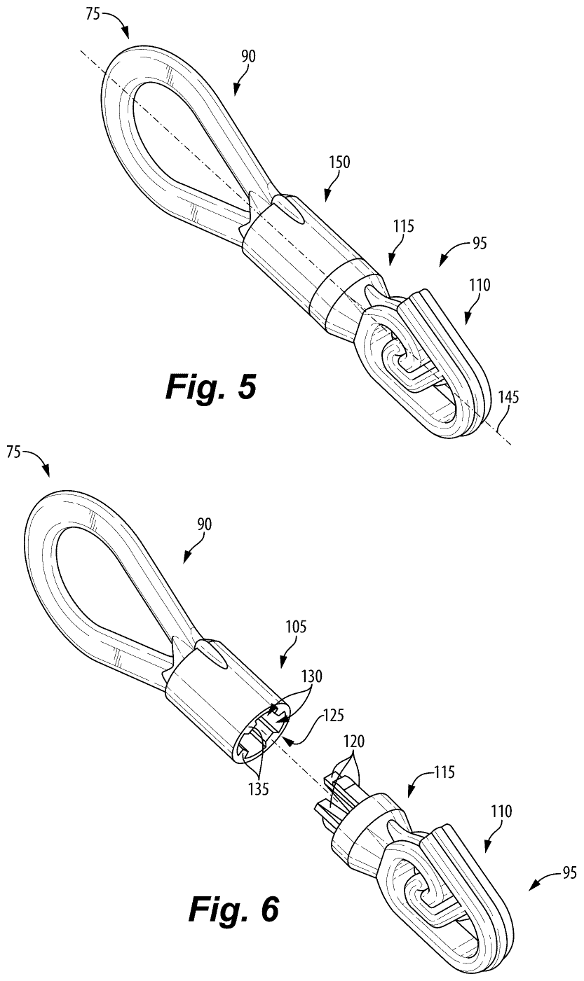

In the example shown herein, the first portion connector 105 is connectable to the second portion connector 115 at two or more radial orientations about the longitudinal axis 145. This is shown by comparing FIGS. 5 and 6 with FIGS. 2 and 3. In FIGS. 2 and 3 the loop 100 is at a first orientation relative to the cable retainer 110. In FIGS. 5 and 6, the loop 100 is rotated 90° about to the longitudinal axis 145 relative to the orientation in FIGS. 2 and 3. In the example shown herein, the layout of the tines 120 and the tine receiving regions 130 facilitate the ability to connect the first portion connector 105 to the second portion connector 115 at four different orientations, as there are four tines 120 and four corresponding tine receiving regions 130. However, if more or less tines 120 and corresponding tine receiving regions 130 are provided, more orientations are possible. The ability to position the loop 100 at different orientations relative to the cable retainer 110 assists with the installation of cable 65 within the linkage 75. It is desirable to maintain a relatively straight orientation (i.e., without kinks in the cable 65) to protect the cable 65, although the location of the structure 70 between the main service connection 60 and the optical network terminal 80 does not always allow for a perfectly straight orientation. In such situations, being able to reorient the loop 100 relative to the cable retainer 110 assists in avoiding kinks or extreme curves in the cable 65 while the linkage 75 supports the cable 65.

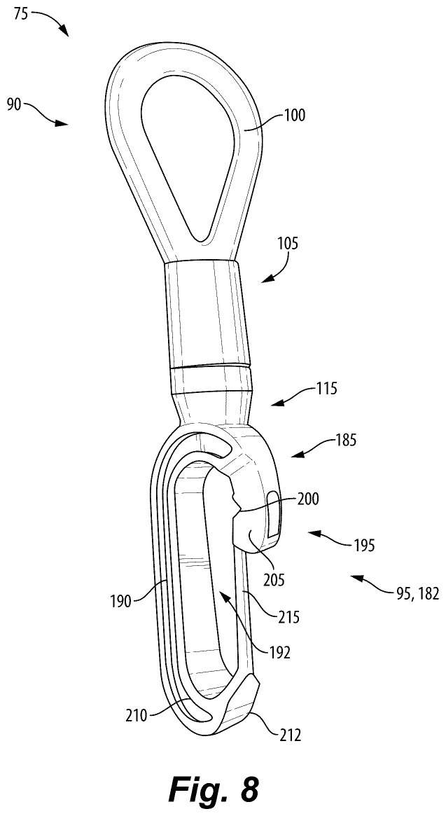

FIGS. 8-10 illustrate another example of the second portion 95 of the linkage 75, which includes features combinable with the other examples disclosed herein. Similar to the example shown in FIG. 2, the linkage 75 in FIG. 8 includes a first portion 90 and a second portion 95. The first portion 90 includes a loop 100 and a first portion connector 105, which connects to the second portion connector 115 of the second portion 95. However, the second portion 95 includes differences from what is shown in FIG. 2, and in general forms a clip 182.

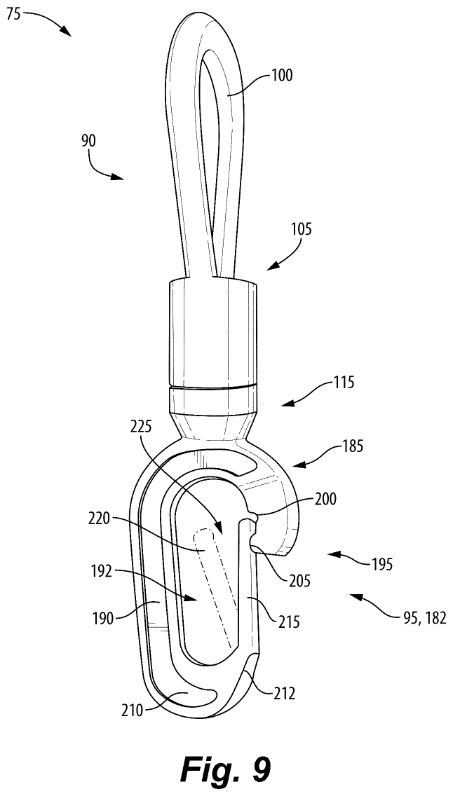

The clip 182 includes a first arm 185 and a second arm 190 extending from the second portion connector 115 and opposite of where the first portion connector 105 is connected to the second portion connector 115. The first arm 185 and the second arm 190 extend separated from one another to form an area 192 for receiving and retaining the cable 65 therein. The first arm 185 includes a nose 195 at the extreme end of the first arm 185. The nose 195 includes a notch 200 and a tooth 205 adjacent to the notch 200. The second arm 190 extends to an elbow 210 at an extreme end of the second arm 190 and opposite of where the second portion connector 115 connects to the second arm 190. The elbow 210 includes a gate 215 connected thereto. The elbow 210 is deformable and flexes about location 212 between a locked position, which is shown in FIG. 8, and an open position, which is shown in FIG. 9. In the open position, the gate 215 is in a second position 220 such that a channel 225 is defined between the nose 195 and the gate 215. Referring back to FIG. 8, in the locked position, the gate 215 extends back toward the second portion connector 115 and contacts the first arm 185. In some examples, in the locked position, the gate 215 extends at least partially around the tooth 205 to seat within the notch 200. Together, the first and second arms 185, 190 and the gate 215 define the area 192, which receives the cable 65 so that the linkage 75 can suspend the cable 65. The gate 215 is articulated to place the cable 65 into or remove the cable from the area 192.

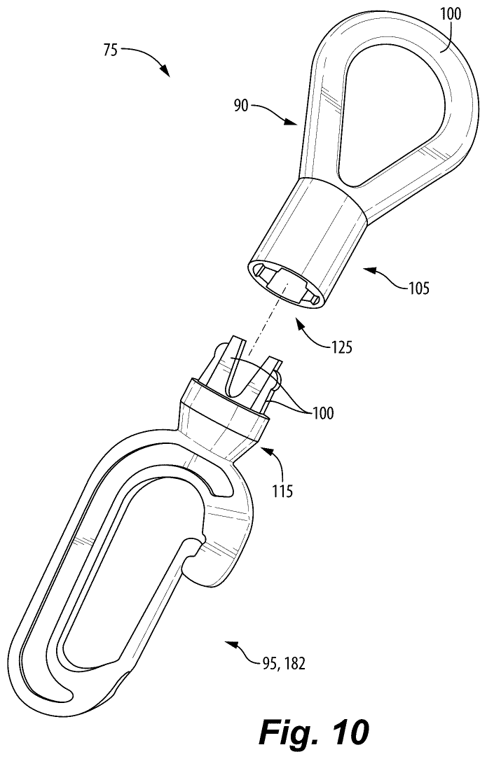

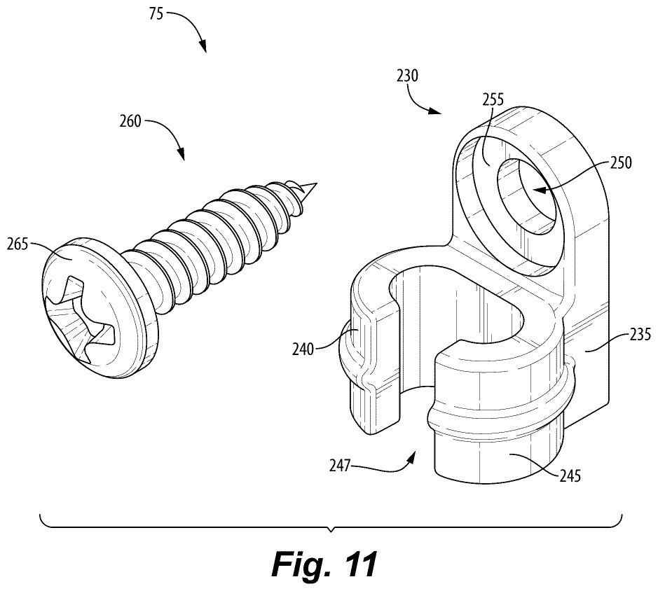

Like the example of the linkage shown in FIG. 2, if a load on the cable 65 reaches a predetermined value, the first portion connector 105 separates the second portion connector 115 to release the cable 65 and thereby protect the cable 65 from damage. As shown in FIG. 10, this is achieved through similar structure as the linkage 75 in FIG. 2. To illustrate this, FIG. 10 shows the linkage of FIG. 8 with the first and second portions 90, 95 separated, revealing the cavity 125 and the tines 120 of the first and second portion connectors 105, 115, respectively.

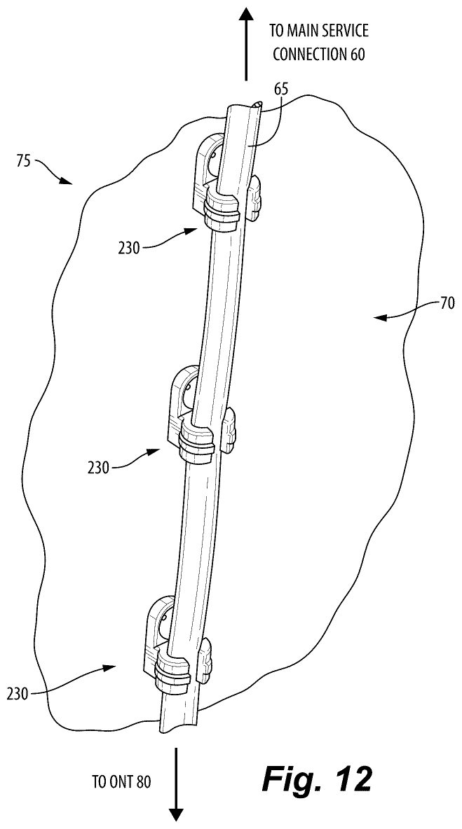

In another example, which is shown in FIGS. 11 and 12, the linkage 75 includes a series of brackets 230 and includes features combinable with the other examples disclosed herein. The bracket 230 include a plate 235 with a first member 240 and a second member 245 extending therefrom. The first and second members 240, 245 are curved to delimit a receiving space 247 such that the cable 65 can be forced into the receiving space 247 to support the cable 65 and retain the cable 65 between the first and second members 240, 245. In use, the plate 235 is mounted directly to the structure 70, as shown in FIG. 12. In the example shown in FIG. 12, the plate 235 is mounted flush against the structure 70. Referring back to FIG. 11, the plate 235 includes an aperture 250 through which a fastener 260 is inserted to retain the bracket 230 against the structure 70. The plate 235 includes a counterbore 255 sized such that a head 265 of the fastener 260 seats within the counterbore 255 when the fastener 260 is installed to retain the bracket 230 against the structure 70, so that the fastener 260 does not interfere with the cable 65 when the cable 65 is installed into the receiving space 247.

Referring now to FIG. 12, a series of brackets 230 are installed onto a structure 70 to support the cable 65 between the main service connection 60 and the optical network terminal 80 and retain the cable 65 against the structure 70. The first and second members 240, 245 are sized to retain the cable 65 until a predetermined load value on the cable 65 is reached. Once the predetermined load value is reached, the cable 65 is pulled by the load from the receiving space 247 between the first and second members 240, 245 and drops to the ground. Like the other examples disclosed herein, this protects the cable 65 from large loads that could damage the cable 65 and disrupt service to the user. FIG. 12 illustrates an assembly of three brackets 230 arranged in series, although depending on the predetermined load limit and the relative orientation of the main service connection 60, structure 70, and optical network terminal 80, different numbers and orientations of the brackets 230 are contemplated to form the linkage 75 assembly.

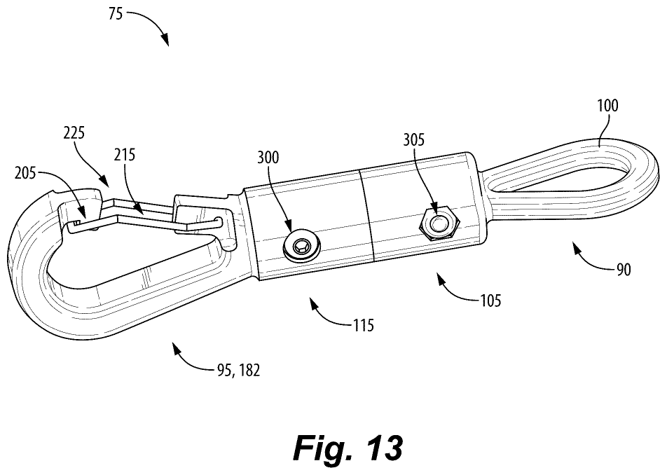

FIGS. 13-16 illustrate another example of the linkage 75, which includes features combinable with the other examples disclosed herein. Similar to the example shown in FIG. 2, the linkage 75 in FIG. 13 includes a first portion 90 and a second portion 95. The first portion 90 includes a loop 100 and a first portion connector 105, which connects to the second portion connector 115 of the second portion 95. The second portion 95 includes the clip 182, which is similar to the example shown in FIG. 8. However, in the example shown in FIG. 13, the gate 215 is a wire that is deformable to perform the function of the gate 215. Referring to both FIG. 12 and FIG. 13, the gate 215 includes a single wire segment, which is folded such that the gate 215 extends from an aperture 320, across the channel 225, around the tooth 205, and back across the channel 225 to another aperture 320. The location of the apertures 320, along with the deformable nature of the gate 215, allow a user to deform the gate 215 such that something to be clipped, for example the cable 65, can pass through the channel 225.

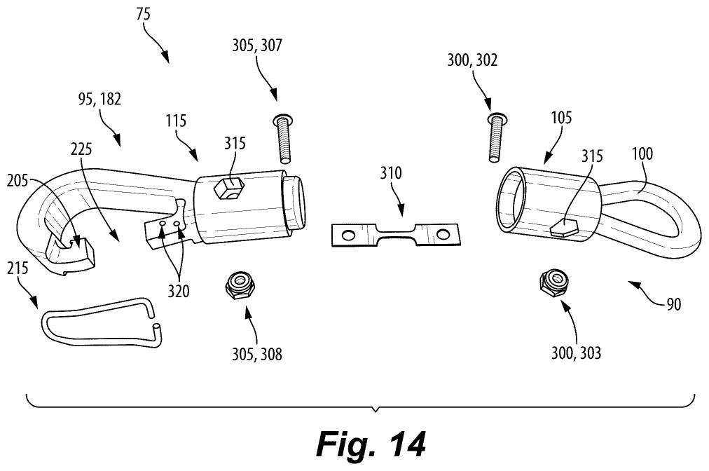

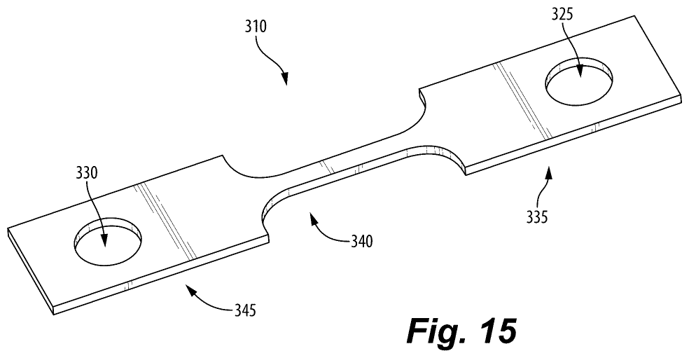

FIGS. 14 and 15 also disclose a different structure for connecting the first portion connector 105 to the second portion connector 115. A link 310 extends from the first portion connector 105 to the second portion connector 115. As seen in FIG. 13, the link 310 is completely obscured when installed in the first portion connector 105 and the second portion connector 115, as the first portion connector 105 sits flush against the second portion connector 115 when the link 310 is installed. To achieve this, the link 310 is received completely within the first portion connector 105 and the second portion connector 115.

The link 310 is retained in the first portion connector 105 by a first retainer 300. In this example, the first retainer 300 includes a first bolt 302 that is connected to a first nut 303. The first bolt 302 passes through a first through-hole 325 in the link 310 (FIG. 15). Similarly, the link 310 is retained in the second portion connector 115 by a second retainer 305. The second retainer 305 includes a second bolt 307 that is connected to a second nut 308. The second bolt 307 passes through a second through-hole 330 in the link 310 (FIG. 15). The first and second bolts 302, 307 and the first and second nuts 303, 308, are seated within recesses 315 in the respective first portion connector 105 and second portion connector 115. The recesses 315 that receive the first and second nuts 303, 308 are shaped to match the shape of the first and second nuts 303, 308 (e.g., hexagonally to correspond to hexagonal nuts), so that the first and second nuts 303, 308 are retained without turning while the first and second bolts 302, 307 are driven into the first and second nuts 303, 308.

Referring now to FIG. 15, the link 310 includes a first portion 335 that includes the first through-hole 325 and a third portion 345 that includes the second through-hole 330. A second portion 340 connects the first portion 335 and the third portion 345. In some examples, the link 310 is a metal, such as steel, although other materials, and in particular other metals, are contemplated. When a sufficient tensile load is applied across the linkage 75 from the first portion 90 to the second portion 95, the second portion 340 of the link 310 breaks at a predictable tensile load, and is sized according to a desired tensile strength. For example, in FIG. 15 the second portion 340 is relatively smaller in cross-sectional area than the first and third portions 335, 345. However, if the second portion 340 were instead similarly sized in cross-sectional area to the first and third portions 335, 345, the linkage 75 would take more tensile load before breaking, and thus the first portion 90 would separate from the second portion 95 at a higher load. The inventors advantageously found that the link 310 as described herein is an easily manufacturable component with a predicable tensile strength. Thus, the linkage 75 when configured to use the link 310 yields a predictable breakaway load. Further, the other components of the linkage 75 (i.e., everything except the link 310) can be the same for numerous applications requiring different tensile strengths (i.e., to result in different breakaway loads), and only the link 310 is changed to result in a different breakaway load of the linkage 75.

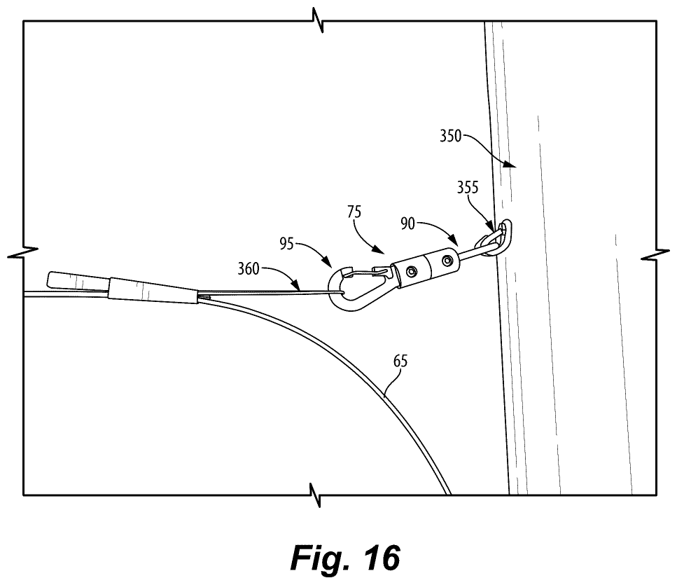

FIG. 16 illustrates the linkage 75 according to FIGS. 13-15 installed on a telephone pole 350. The first portion 90 is connected to the telephone pole 350 via a first connection 355, which in this example is in the form of a ram's horn connection, i.e., a metal loop bolted to the telephone pole 350. The second portion 95 is connected to the cable 65 via a second connection 360, which in this example is a wired connection that is clamped to the cable 65. Other examples of the first connection 355 and the second connection 360 are contemplated.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A linkage for retaining a cable to a structure, the cable being configured to run between a main service connection and a user connection, the linkage comprising:
a first portion configured to connect to the structure, and
a second portion configured to retain the cable therein such that the cable is retained to the structure via the first portion,
wherein the linkage is configured such that the cable detaches from the structure at a predetermined load value applied to the cable.

2. The linkage of claim 1, wherein the predetermined load value is 100 lbs to 600 lbs.

3. The linkage of claim 1, wherein the first portion includes a loop for attaching to the structure and a first portion connector,
wherein the second portion includes a cable retainer and a second portion connector that is connectable to the first portion connector, and
wherein the first portion connector and the second portion connector are configured to detach from one another when the predetermined load value is reached.

4. The linkage of claim 3, wherein a link connects the first portion connector to the second portion connector, and
wherein the link is configured to break at a predetermined tensile load applied between the first portion connector and the second portion connector.

5. The linkage of claim 4, wherein the link includes a first portion, a second portion, and a third portion,
wherein the first portion is connected to the first portion connector, and
wherein the third portion is connected to the second portion connector.

6. The linkage of claim 5, wherein the second portion connects the first portion to the third portion, and wherein the second portion has a smaller cross-sectional area than the first portion and the third portion.

7. The linkage of claim 5, wherein the first portion includes a first through-hole and the third portion includes a second through-hole, wherein the first portion is connected to the first portion connector via a first bolt that passes through the first through-hole, and wherein the third portion is connected to the second portion connector via a second bolt that passes through the second through-hole.

8. The linkage of claim 5, wherein the link is metal.

9. The linkage of claim 5, wherein the link is received within the first portion connector and the second portion connector.

10. The linkage of claim 9, wherein the first portion connector sits flush against the second portion connector.

11. The linkage of claim 1, wherein the first portion includes a loop for attaching to the structure and a first portion connector,
wherein the second portion includes an area for receiving the cable and a second portion connector that is connectable to the first portion connector, and
wherein the first portion connector and the second portion connector are configured to detach from one another when the predetermined load value is reached.

12. The linkage of claim 11, wherein the area for receiving the cable is delimited by a first arm and a second arm spaced apart from the first arm, and
wherein the area for receiving the cable is located between the first arm and the second arm.

13. The linkage of claim 12, wherein the second arm includes an elbow at an end of the second arm opposite of the second portion connector, and
wherein the elbow is attached to a gate, and the gate is configured to be actuated in contact with and out of contact with the first arm.

14. The linkage of claim 13, wherein the elbow and the gate also delimit the area for receiving the cable.

15. The linkage of claim 14, wherein the elbow is deformable at a flexing location such that the gate is movable between a first position and a second position, the gate contacting the first arm in the first position and being spaced away from the first arm in the second position.

16. The linkage of claim 15, wherein the first arm includes a tooth in part defined by a notch, and wherein the gate is configured to, in the first position, extend at least partially around the tooth to seat within the notch.

17. The linkage of claim 1, wherein the linkage is a bracket that is configured to attach directly to the structure, the bracket including a first member and a second member spaced apart from the first member to define a receiving space therebetween, the receiving space configured to receive and retain the cable until the predetermined load value is applied to the cable.

18. The linkage of claim 17, wherein the bracket includes an aperture configured to receive a fastener to attach the bracket to the structure, and
wherein the bracket includes a counterbore around the aperture, the counterbore being configured to receive a head of the fastener.

19. The linkage of claim 18, wherein the first member and the second member attach to a plate configured to sit flush against the structure in an installed position.

20. The linkage of claim 19, wherein the bracket is one of a plurality of brackets, and wherein the linkage is an assembly comprising the plurality of brackets.
